(19) United States
(12) Patent Application Publication
(10) Pub. No.: US 2025/0112304 A1
(43) Pub. Date: Apr. 3, 2025

(54) BATTERY SYSTEM WITH IMPROVED THERMAL RESISTANCE

(71) Applicant: SAMSUNG SDI CO., LTD., Yongin-si (KR)

(72) Inventors: Wolfgang REINPRECHT, Attendorf (AT); Stefan REINPRECHT, Attendorf (AT)

(21) Appl. No.: 18/792,103

(22) Filed: Aug. 1, 2024

(30) Foreign Application Priority Data
Sep. 28, 2023 (EP) 23200580.1

(51) Int. Cl. H01M 50/131; H01M 50/117; H01M 50/119; H01M 50/121; H01M 50/122; H01M 50/124; H01M 50/249; H01M 50/367

(52) U.S. Cl. CPC H01M 50/131; H01M 50/117; H01M 50/119; H01M 50/121; H01M 50/122; H01M 50/1245; H01M 50/249; H01M 50/367; H01M 2220/20

(57) ABSTRACT

A battery cell includes: a metal cell housing having a top side, a bottom side, and side walls, the housing has a venting exit to allow a venting gas stream to exit from the housing at the top side and/or at the bottom side of the housing to form a venting side of the battery cell; and a cell sheathing covering an outer surface of the top side, the bottom side, and the side walls of the housing. The cell sheathing includes a composite material including a fiber mat embedded in a matrix support material. The cell sheathing has a venting opening at the venting side and aligned with the venting exit to allow the venting gas stream to pass through the cell sheathing.

### CROSS-REFERENCE TO RELATED APPLICATION

The present application claims priority to and the benefit of European Patent Application No. 23200580.1, filed on Sep. 28, 2023, in the European Patent Office, the entire disclosure of which is incorporated herein by reference.

### BACKGROUND

### 1. Field

Aspects of embodiments of the present disclosure relate to a battery system and a vehicle including the battery system.

### 2. Description of the Related Art

In recent years, vehicles for transportation of goods and people have been developed that use electric power as a source for motion. Such electric vehicles are automobiles that are propelled by an electric motor using energy stored in rechargeable batteries. An electric vehicle may be solely powered by batteries or may be a hybrid vehicle powered by, for example, a gasoline generator. Furthermore, the vehicle may include a combination of an electric motor and a conventional combustion engine.

Generally, an electric-vehicle battery (EVB) or traction battery is a battery used to power the propulsion of battery electric vehicles (BEVs). Electric-vehicle batteries differs from starting, lighting, and ignition batteries in that they are designed to output power for sustained periods of time.

A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such 1 as cellular phones, notebook computers, and camcorders, while high-capacity rechargeable batteries are used as power supplies for hybrid vehicles and the like.

Generally, a rechargeable (or secondary) battery cell includes an electrode assembly including a positive electrode, a negative electrode, and a separator interposed between the positive and negative electrodes, a case accommodating the electrode assembly, and an electrode terminal electrically connected to the electrode assembly. An electrolyte solution is injected into the case to enable charging and discharging of the battery cell via an electrochemical reaction between the positive electrode, the negative electrode, and the electrolyte solution. The shape of the case, such as a cylindrical or rectangular shape, may be selected based on the battery's intended purpose. Lithium-ion (and similar lithium polymer) batteries, widely known via their use in laptops and consumer electronics, are the dominant form of secondary batteries the most recent electric vehicles in development.

Rechargeable batteries may be used as a battery module including a plurality of unit battery cells coupled to each other in series and/or in parallel to provide high power density, such as for motor driving of a hybrid vehicle. For example, the battery module may be formed by interconnecting the electrode terminals of the plurality of unit battery cells in an arrangement or configuration depending on a desired amount of power and to provide a high-power rechargeable battery.

Battery modules can be constructed in either a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include of a plurality of battery modules connected together in series to provide a desired voltage.

The battery modules may include submodules including a plurality of stacked battery cells (e.g., a battery stack or stack), and each stack includes cells connected together in parallel that are, in turn, connected in series (XpYs) or cells connected together in series that are, in turn, connected in parallel (XsYp).

A battery pack is a set of any number of (usually identical) battery modules. The battery modules may be connected in a series, parallel, or series/parallel connection configuration to provide a desired voltage, capacity, and/or power density. Components of a battery pack include the individual battery modules and the interconnects, which provide electrical conductivity between the battery modules.

To provide thermal control of the battery pack, a thermal management system may be employed to safely use the battery modules by efficiently emitting, discharging, and/or dissipating heat generated from the rechargeable batteries therein. If the heat emission/discharge/dissipation is not sufficiently performed, temperature deviations may occur between respective battery cells and the battery modules may not generate a desired amount of power. In addition, an increase in the internal temperature of the battery cells may lead to abnormal reactions occurring therein, and thus, charging and discharging performance of the rechargeable batteries may deteriorate and the life-span of the rechargeable batteries may be shortened. Thus, cell cooling to effectively emit/discharge/dissipate heat from the battery cells is desired.

Exothermic decomposition of cell components may lead to a so-called thermal runaway. Generally, thermal runaway describes or refers to a process that accelerates due to increased temperature, in turn releasing energy that further increases temperature. Thermal runaway occurs in situations when an increase in temperature changes the conditions in a way that causes a further increase in temperature, often leading to a destructive result.

In rechargeable battery systems, thermal runaway is associated with strong exothermic reactions that are accelerated by temperature rise. These exothermic reactions include combustion of flammable gas compositions within the battery pack housing. For example, when a cell is heated above a critical temperature (typically above about 150° C.) the battery cell can transition into a thermal runaway. The initial heating may be caused by a local failure, such as a battery cell internal short circuit, heating from a defective electrical contact, short circuiting to a neighboring battery cell, etc. During the thermal runaway, a failed battery cell, that is, a battery cell which has or is experiencing a local failure, may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is, therefore, flammable and potentially toxic. The vented gas also causes a gas-pressure to increase inside the battery pack.

Battery cells in a battery system may be insulated with plastic foil providing electrical insulation with the side walls and bottom of a battery housing within normal operating temperatures of up to about 150° C. The battery cells are squeezed or glued into the cell compartment of the battery housing towards the bottom and side walls while the top side (or upper side or end) of the battery cells is usually uncovered. During heating-up of a damaged battery cell caused by, for example, a thermal runaway inside the battery cell, the plastic foil may melt, causing a loss of electrical insulation. This may result in a low electrical resistance between parts or components with high differential voltage (e.g., at least about 20V), causing internal short circuits and/or arcing between these parts/components. For example, the housings of the battery cells, which usually consist of aluminum, may be electrically conductive at such voltages such that the internal short circuits and/or arcing may occur with neighboring battery cells due to the loss of the electrical insulation between the battery cells.

### SUMMARY

According to embodiments of the present disclosure, at least some of the drawbacks of the prior art are overcome by providing a battery cell that more securely handles a thermal runaway by preventing short circuits and/or arcing.

The present disclosure is defined by the appended claims and their equivalents. The description that follows is subject to this limitation. Any disclosure lying outside the scope of the claims is intended for illustrative as well as comparative purposes.

According to an embodiment of the present disclosure, a battery cell includes: a metal cell housing having a top side, a bottom side, and side walls, the housing has a venting exit to allow a venting gas stream to exit from the housing at the top side and/or at the bottom side of the housing to form a venting side of the battery cell; and a cell sheathing covering an outer surface of the top side, the bottom side, and the side walls of the housing. The cell sheathing includes a composite material including a fiber mat embedded in a matrix support material. The cell sheathing has a venting opening at the venting side and aligned with the venting exit to allow the venting gas stream to pass through the cell sheathing.

The battery cell may further include electrode terminals arranged at the top side of the battery cell. The cell sheathing may have openings that the electrode terminals extend through.

The fiber mat may include glass fibers, basalt fibers, and/or mica fibers.

The matrix support material may include a resin and/or glue.

The matrix support material may include an epoxy and/or polyurethane binder.

The cell sheathing may further include a flame retardant.

The composite material may be an FR-4 composite material.

The cell sheathing may be adapted to a contour of the outer surface of the top side, the bottom side, and the side walls of the cell housing.

According to another embodiment of the present disclosure, a battery system includes a battery housing accommodating a plurality of the battery cells as described above. The battery cells may be arranged to form one or more battery packs and/or battery modules.

According to another embodiment of the present disclosure, an electric vehicle includes the battery system described above.

According to another embodiment of the present disclosure, an electric vehicle includes the battery cell described above.

According to another embodiment of the present disclosure, an energy storage system (ESS) includes the battery system described above.

Further aspects and features of the present disclosure can be learned from the dependent claims, the following description, or practice of the described embodiments.

### BRIEF DESCRIPTION OF THE DRAWINGS

Aspects and features of the present disclosure will become apparent to those of ordinary skill in the art by describing, in detail, embodiments thereof with reference to the attached drawings in which:

FIG. 1 is a schematic cross-sectional view of a battery cell according to an embodiment.

FIG. 2 is a schematic top view of the battery cell shown in FIG. 1.

FIG. 3 is a schematic cross-sectional view of a battery cell according to another embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to embodiments the illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. For example, the terms “upper” and “lower” are defined according to the z-axis, such that, as one example, the upper cover is positioned at the upper part of the z-axis, and the lower cover is positioned at the lower part thereof. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

According to an embodiment of the present disclosure, a battery cell is provided. The battery cell may be one of a plurality of battery cells of a traction battery of an electric vehicle. The battery cell includes a cell housing, inside of which an electrochemical cell (e.g., an electrode assembly) is arranged. The cell housing may be a metal cell housing; for example, the cell housing may consist of or may include metal or may primarily include metal. In one embodiment, the metal cell housing may be an aluminum cell housing; for example, the cell housing may consist of or may include aluminum or may primarily include aluminum. The metal cell housing is electrically conductive at voltages that may occur during the normal operation of the battery cell as part of a traction battery of an electric vehicle and/or at voltages that may occur during a thermal runaway occurring inside of the battery cell.

In one embodiment, the cell housing has a top side, a bottom side, and side walls. The cell housing may be prismatic, for example, in the form of a cuboid. In such an embodiment, the cell housing may have six sides—the top side, the bottom side, and four side walls.

In another embodiment, the cell housing (and, thus, the battery cell) may be cylindrical having two circular areas that are parallel to each other and a lateral surface connecting (or extending between) the two circular surfaces, with the side wall forming the lateral surface of the cylinder. For example, in a cylindrical cell housing (and, thus, a cylindrical battery cell) the lateral surface of the cylinder may be considered to form the side wall, one of the circular areas may be considered to form the top side, and the other of the circular areas may be considered to form the bottom side of the cell housing.

The battery cell has at least one venting exit at a venting side of the battery cell, which may also be the terminal side of the battery cell, that is, the side that includes electrode terminals for electrically connecting the battery cell with further battery cells and/or with an electric motor of an electric vehicle. The venting exit is configured to allow a venting gas stream to escape the battery cell during a thermal runaway of the battery cell. A venting valve may be arranged at (or in) the venting exit. The venting side of the battery cell may be the top side and/or the bottom side of the battery cell; that is, a venting exit may be provided at the top side and/or the bottom side of the battery cell.

Further, the battery cell according to an embodiment of the present disclosure includes a cell sheathing covering the outer surface of the cell housing. Covering, as used herein, refers to the cell sheathing entirely surrounding or substantially surrounding the cell housing where the cell sheathing is in direct contact with the outer surface of the cell housing. For example, the cell sheathing sheathes or envelopes or encases the cell housing from the outside. In one embodiment, the cell sheathing completely covers the outer surface of the cell housing. In other words, the whole outer surface of the cell housing may be covered by the cell sheathing. However, the venting exit of the battery cell and the electrode terminals of the battery cell are not covered by the cell sheathing. Thus, the top side, the bottom, and all of the side walls of the cell housing are covered by the cell sheathing. In a prismatic cell housing, the top side, the bottom side, and all of the four side walls may be covered (e.g., completely covered) by the cell sheathing. In a cylindrical battery cell, both circular surfaces and the lateral surface may be covered (e.g., completely covered) by the cell sheathing.

The cell sheathing includes, or consists of, a fiber mat embedded in a matrix support material such the combination of the fiber mat and the matrix support material form a composite material. Within the fiber mat, the fibers are not loosely arranged but are instead arranged (e.g., purposefully or intentionally arranged). For example, the fiber mat is a woven fabric, that is, the fibers are woven or interlaced to form a fabric/mat. The matrix support material provides stability to the fiber mat. The cell sheathing includes, at the venting side, a venting opening aligned with the venting exit of the battery cell for letting the venting gas stream pass through the cell sheathing. The venting opening may be (or may include) a cut-out in the cell sheathing. The venting opening may correspond in form and size to that of the venting exit it is aligned with. Also, the venting opening may be a simple cut along a line. Such a cut may be sufficient to let the venting gas stream pass therethrough while the cell sheathing may still prevent contaminants from entering the battery cell through the venting exit from the outside. The cell sheathing may be fixed to the outer surface of the cell housing, for example, via glue.

The cell sheathing, according to an embodiment of the present disclosure, provides thermally stable electrical insulation to the battery cell by covering the outer surface of the cell housing. The cell sheathing provides electrical and thermal insulation. Because the cell sheathing surrounds the cell housing on all sides, the battery cell is (electrically) insulated on all sides. The battery cell is insulated against any neighboring battery cells. As explained above, cell insulation, such as plastic foil, melt during a thermal runway due to the high temperatures (about 1000° C. and higher), which results in loss of electrical insulation. This problem is overcome with the cell sheathing according to embodiments of the present disclosure because the cell sheathing may withstand these temperatures. The cell sheathing, due to its composite material, provides improved insulation during a thermal runaway of the battery cell itself or of a neighboring battery cell because, while at the high temperatures occurring during a thermal runaway, the matrix support material may be destroyed but the fiber mat may still maintain its structure and its electrical insulation properties. The composite material ensures that the cell sheathing is stable but still flexible, which eases assembly. Nevertheless, albeit not being mechanically rigid, the cell sheathing provides sufficient electrical insulation and also sufficient thermal insulation such that thermal propagation of the thermal runaway to further battery cells is mitigated or prevented. Thus, the cell sheathing according to embodiments of the present disclosure provides a heat resistant covering on an outside of the cell housing so that, in case of a thermal runaway, the cell housing remains electrically insulated (e.g., its electrical insulation stays intact). The battery cell may degas through its venting exit in a controlled manner due to the venting opening provided in the cell sheathing. Thus, the cell sheathing, while covering the venting side (e.g., the top side or bottom side of the cell housing) nevertheless allows for the venting gas stream to exit the battery cell. The cell sheathing, thus, completely covers the outer surface of the battery cell, that is. the top side, bottom side, and any side walls except for the venting exit(s) and except for the electrode terminals. The cell sheathing may provide thermal insulation to the battery cell by, for example, shielding the battery cell from any venting products which may deposit onto the cell sheathing from the outside (e.g., from an adjacent battery cell). The battery cell according to embodiments of the present disclosure is, thus, capable of maintaining its electrical insulation during a thermal runaway and, thus, more securely handles the thermal runaway. The cell sheathing may provide a “one-piece” insulation with a tight fit to the cell housing.

According to an embodiment, the battery cell includes electrode terminals arranged at the top side of the battery cell, and the cell sheathing has openings for the electrode terminals to extend through. The electrode terminals may also be referred to as cell terminals. The electrode terminals are the electrical poles of the battery cell for accessing the electrical power stored within the electrochemical cell and for electrical connection of the battery cell with one or more other battery cells of a battery module/system. Neighboring battery cells may be interconnected with one another via electrical connecting means contacting the electrode terminals of the respective battery cells, such as wires or busbars. The electrode terminals extend through the cell sheathing such that the cell sheathing does not cover the electrode terminals. Thus, the cell sheathing completely covers the outer surface of the battery cell, that is, the top side, bottom side, and any side walls except for the venting exit(s) and except for the electrode terminals. In other words, from among the entire outer surface of the cell housing and, thus, of the battery cell, merely the electrode terminals and the venting exit are exposed by (e.g., are not covered by) the cell sheathing. As explained, the cell sheathing covering the entire outer surface of the cell housing provides improved insulation during a thermal runaway. The cell sheathing not covering the electrode terminals allows for easy electrical connection of the electrode terminals with, for example, further battery cells. The electrode terminals may, however, be covered by a cover element after the battery cell has been placed into a battery housing of a battery system along with further battery cells, that is, after assembly of the battery system. The openings for the electrode terminals may be formed as cut-outs in the cell sheathing as this is simple to manufacture.

According to an embodiment, the fiber mat includes one or more of the following: glass fibers, basalt fibers, mica fibers. These fibers may form a woven fabric, as mentioned above. Mica may refer to mica silicate minerals. The matrix support material is or includes a resin and/or a glue. The matrix support material is or includes an epoxy and/or a polyurethane binder. These fibers and matrix support materials provide a flexible and thermally stable cell sheathing that can be easily arranged to cover the (entire) outer surface of the cell housing, as explained above, while providing sufficient electrical insulation even during a thermal runaway.

According to an embodiment, the cell sheathing further includes a flame retardant. The flame retardant is activated by the high temperatures occurring during a thermal runaway and prevents or at least slows further heat propagation. The flame retardant further improves the capabilities of the cell sheathing to withstand the high temperatures occurring during a thermal runaway so that the cell sheathing provides reliable electrical insulation of the battery cell.

According to an embodiment, the composite material of the cell sheathing is or includes an FR-4 composite material. FR-4 is a composite material composed of woven fiberglass fabric with an epoxy resin binder that is flame resistant (e.g., self-extinguishing) according to the National Electrical Manufacturers Association (NEMA) grade designation for glass-reinforced epoxy laminate material. An FR-4 composite material is suited to withstand the high temperatures occurring during a thermal runaway and, thus, is suited to provide reliable electrical insulation of the battery cell.

According to an embodiment, the cell sheathing is adapted to the contour of the outer surface of the cell housing including the top side, the bottom side, and side walls. Being adapted to the contour means that the cell sheathing has a shape corresponding to the shape of the elements it covers. The contour or form of the cell sheathing may be adapted to the contour of outer surface of the cell housing, for example, the top side, bottom side, and all the side walls of the cell housing. The cell sheathing is suited for such adaptation because it is relatively flexible due to the fiber mat but may still keep its form due to the matrix support material. Such adaptation of the cell sheathing to the covered parts provides improved electrical and thermal insulation. Also, this leaves less or no access for the venting products to reach the covered parts and, thus, allows for a reliable shielding.

Another embodiment of the present disclosure pertains to a battery system including one or more of the battery cells as described above. The battery system may include a battery housing and a plurality of the battery cells accommodated inside the housing, thus forming a battery housing. The battery housing may also be considered as a cell compartment for the battery cells. The battery cells may be interconnected via electrical connecting means, such as busbars, contacting respective electrode/cell terminals of the battery cells to form one or more battery modules/battery packs. The battery cells may be arranged to form one or more battery packs, and in a battery pack, the battery cells are electrically interconnected in a series and/or in parallel. Multiple of these battery packs may form a battery module. Two or more of the battery packs may be stacked to form cell stacks. The battery cells may be, for example, prismatic or cylindrical cells. Each of the battery cells may include a metal housing with a top side, a bottom side, and with side walls extending from the top side to the bottom side. Each of the battery cells may include a venting exit at a venting side of the battery cell, the venting exits allowing a venting gas stream to escape the battery cells during a thermal runaway. Venting valves may be provided at the venting exits. The venting side may be the top side and/or the bottom side of the battery cells. For example, venting exits may be provided at the top side and/or the bottom side of the battery cells. Each of the battery cells may include a cell sheathing as described above.

Another embodiment of the present disclosure pertains to an electric vehicle including a battery system as described above.

Another embodiment of the present disclosure pertains to an energy storage system (ESS) including a battery system as described above.

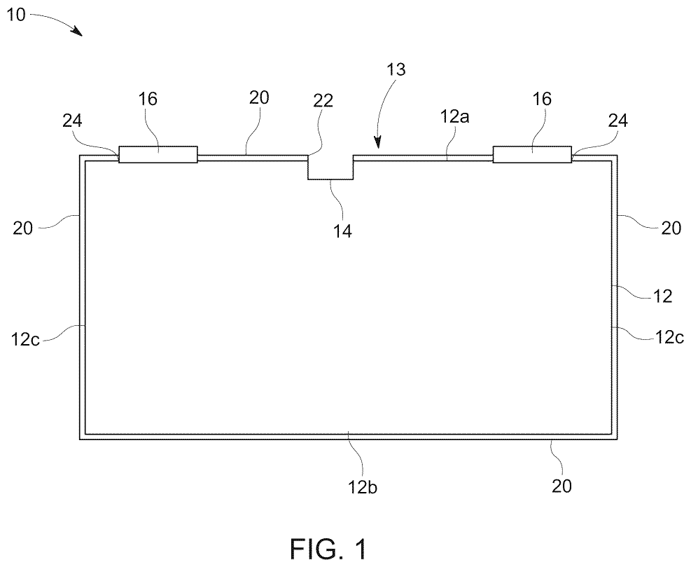

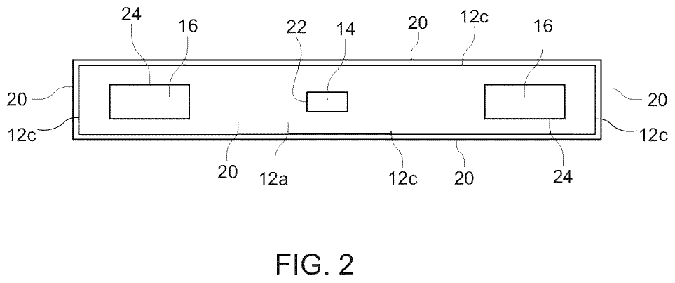

FIGS. 1 and 2 schematically illustrate a battery cell 10 according to an embodiment of the present disclosure. FIG. 1 shows a cross-sectional view of the battery cell 10, and FIG. 2 shows the battery cell 10 from above.

The battery cell 10 includes an electrochemical cell encased by a cell housing 12. The cell housing 12 includes aluminum. The cell housing 12 is, thus, a metal cell housing, which is electrically conductive at least at a sufficiently high differential voltage, for example, at least about 20 V.

The cell housing 12 has a cuboid shape and has a top side 12a, a bottom side 12b, and four side walls 12c. The top side 12a forms (or is) a venting side 13 of the battery cell 10 because the battery cell 10 includes a venting exit 14 at that side. During a thermal runaway occurring inside the battery cell 10, a venting gas stream may exit the battery cell 10 through the venting exit 14. A venting valve may be provided at (or in) the venting exit 14. Further, the battery cell 10 includes electrode terminals 16 at the top side 12a and, thus, at the top side 12a of the cell housing 12, the electrode terminals 16 form electrical poles.

The battery cell 10 further includes a cell sheathing 20 surrounding the battery cell 10 from all sides, thereby covering the outer surface of the cell housing 12 including the top side 12a, the bottom side 12b, and all of the side walls 12c. The cell sheathing 20 directly abuts the outer surface of the cell housing 12 and, thus, the aluminum material. The cell sheathing 20 is adapted to the contour of the outer surface of the cell housing 12, that is, the top side 12a, the bottom side 12b, and the side walls 12c. The cell sheathing 20 may be glued directly to and in close contact to the outer surface of the cell housing 12.

The cell sheathing 20 has openings merely at the locations of the electrode terminals 16 and at the location of the venting exit 14. For example, the cell sheathing 20 includes a venting opening 22 at the top side 12a of the battery cell 10 that is aligned with the venting exit 14. The venting opening 22 may be formed by a cut or cut-out. Therefore, the venting gas stream exhausted outwardly from the venting exit 14 may pass through the cell sheathing 20 to the outside of the battery cell 10. Further, the cell sheathing 20 has two openings 24, one for each of the two electrode terminals 16. The electrode terminals 16 extend through the openings 24 and, thus, through the cell sheathing 20. The openings 24 may be formed via cut-outs.

The cell sheathing 20 is, in one embodiment, made of an FR-4 composite material including glass and/or basalt fibers in the form of a fiber mat tightened by (or fixed by) a composite glue, such as epoxy or polyurethane. The cell sheathing 20 is flexible while providing improved thermal and electrical insulation properties compared to other cells insulations, such as plastic foils.

During a thermal runaway, temperatures of about 1000° C. and more may be reached, which the cell sheathing 20 may withstand due to the cell sheathing 20. The cell sheathing 20 sufficiently protects the battery cell 10 from electrical faults, such as internal short circuits or arcing between neighboring cells, because the cell sheathing 20 maintains its electrical insulation properties even during the thermal runaway. With the cell sheathing 20 covering the entire cell housing from all its sides, the battery cell 10 is sufficiently insulated. The cell sheathing 20 provides a “one-piece” insulation with a tight fit to the cell housing 12. The battery cell 10, according to embodiments of the present disclosure, is, thus, capable of maintaining its electrical insulation during a thermal runaway and more securely handles the thermal runaway.

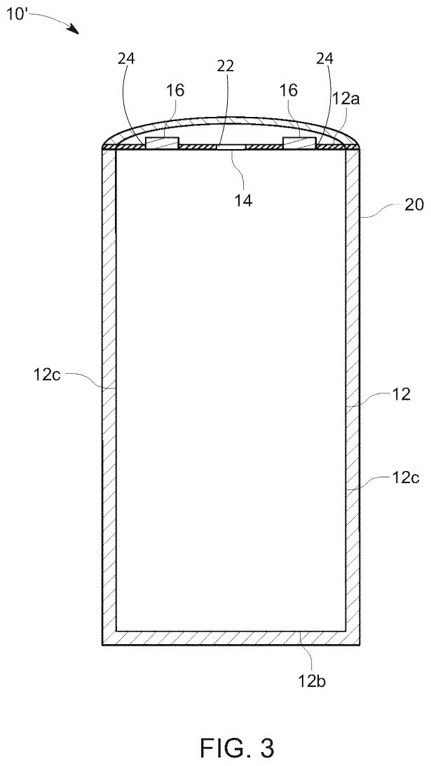

FIG. 3 illustrates a battery cell 10′ according to another embodiment of the present disclosure. The battery cell 10′ is a cylindrical battery cell with a cell housing 12 having a cylindrical shape. In this embodiment, the cell housing 12 also has a top side 12a and a bottom side 12b, which are formed by the circular surfaces of the cell housing 12, and a side wall 12c which is formed by the lateral surface of the cell housing 12. In this embodiment, a cell sheathing 20 consequently also has a cylindrical shape and covers the cell housing 12 completely from all sides except openings 24 for through which electrode terminals 16 extend and a venting opening 22 in alignment with a venting exit 14. Thus, cylindrical battery cells may also be outfitted with the cell sheathing 20 according to embodiments of the present disclosure, thereby providing thermally stable electrical insulation.

### SOME REFERENCE NUMERALS

10 battery cell
10′ battery cell
12 cell housing
12a top side
12b bottom side
12c side walls
13 venting side
14 venting exit
16 electrode terminals
22 venting opening
24 openings for electrode terminals

What is claimed is:

1. A battery cell comprising:
a metal cell housing having a top side, a bottom side, and side walls, the housing has a venting exit to allow a venting gas stream to exit from the housing at the top side and/or at the bottom side of the housing to form a venting side of the battery cell; and
a cell sheathing covering an outer surface of the top side, the bottom side, and the side walls of the housing, the cell sheathing comprises a composite material comprising a fiber mat embedded in a matrix support material,
wherein the cell sheathing has a venting opening at the venting side and aligned with the venting exit to allow the venting gas stream to pass through the cell sheathing.

2. The battery cell according to claim 1, further comprising electrode terminals arranged at the top side of the battery cell,
wherein the cell sheathing has openings that the electrode terminals extend through.

3. The battery cell as claimed in claim 1, wherein the fiber mat comprises glass fibers, basalt fibers, and/or mica fibers.

4. The battery cell as claimed in claim 1, wherein the matrix support material comprises a resin and/or glue.

5. The battery cell as claimed in claim 1, wherein the matrix support material comprises an epoxy and/or polyurethane binder.

6. The battery cell as claimed in claim 1, wherein the cell sheathing further comprises a flame retardant.

7. The battery cell as claimed in claim 1, wherein the composite material is an FR-4 composite material.

8. The battery cell as claimed in claim 1, wherein the cell sheathing is adapted to a contour of the outer surface of the top side, the bottom side, and the side walls of the cell housing.

9. A battery system comprising a battery housing accommodating a plurality of the battery cells as claimed in claim 1,
wherein the battery cells are arranged to form one or more battery packs and/or battery modules.

10. An electric vehicle comprising the battery system as claimed in claim 9.

11. An electric vehicle comprising the battery cell as claimed in claim 1.

12. An energy storage system comprising the battery system as claimed in claim 9.
